(19) United States
(12) Patent Application Publication
(10) Pub. No.: US 2010/0035665 A1
(43) Pub. Date: Feb. 11, 2010

(54) ADAPTIVE COMMUNICATION DEVICE AND METHOD THEREOF

(75) Inventor: Gary Munson, Little Silver, NJ (US)

Correspondence Address: AT&T Legal Department - AS;Attn: Patent Docketing, Room 2A-207, One AT&T Way, Bedminster, NJ, 07921, US

(73) Assignee: AT&T INTELLECTUAL PROPERTY I, L.P., RENO, NV (US)

(21) Appl. No.: 12/189,633

(22) Filed: Aug. 11, 2008

(51) Int. Cl. H04M 1/02; G06F 1/16

(52) U.S. Cl. 455/575.1; 361/679.4; 361/679.08; 361/679.21

(57) ABSTRACT

A system that incorporates teachings of the present disclosure may include, for example, a computing device having a User Interface (UI), one or more electromechanical elements, a controller that manages operations of the UI, and the one or more electromechanical elements, and a housing assembly with an ergonomic form-factor for carrying in whole or in part the UI, the one or more electromechanical elements, and the controller. The controller can be adapted to detect a triggering event, and cause at least one of the one or more electromechanical elements to adjust the ergonomic form-factor responsive to the detected triggering event. Additional embodiments are disclosed.

### FIELD OF THE DISCLOSURE

The present disclosure relates generally to communication devices and more specifically to an adaptive communication device and method thereof.

### BACKGROUND

Computing devices such as cellular phones, and laptop computers come in many form-factors. For example, cellular phones can be housed in “candy bar” form-factors, “flip” form-factors, “candy bar with slider” form-factors, and so on. Candy bar form-factors typically have a rectangular housing assembly with a keyboard and display on the same side. Flip form-factors typically have a housing assembly with a keyboard on one flip subassembly and a display on another flip subassembly coupled by a cam mechanism at a common edge of the flip subassemblies, thereby providing its user a means to open the flip subassemblies at an obtuse angle, or close the flip subassemblies in a clamshell-like position for compactness. Candy bar with slider form-factors typically have a housing assembly with a keypad, and concealed Qwerty keyboard that slides out of the housing assembly responsive to a user manually retrieving the keyboard.

Laptop computers generally have a flip form-factor with a large display on one flip subassembly, and a large Qwerty keyboard on another flip subassembly. Both subassemblies are generally coupled by one or more axle mechanisms at a common edge of the flip subassemblies, thereby providing its user a means to close the flip subassemblies for compactness and transport, or open the subassemblies at an obtuse angle. Some laptop computers allow for the separation of flip subassemblies when one of the subassemblies has a touch screen display with computer functionality. Other laptop computers also allow the flip subassembly carrying the display to rotate 180 degrees or more about a central axis that connects to the flip subassembly carrying the Qwerty keyboard.

Other form-factors are available for computing devices.

### BRIEF DESCRIPTION OF THE DRAWINGS

FIG. 1 depicts an illustrative embodiment of a computing device;

FIG. 2 depicts an illustrative method operating in the computing device of FIG. 1;

FIGS. 3-8 depict illustrative form-factors of the computing device of FIG. 1; and

FIG. 9 depicts an illustrative diagrammatic representation of a machine in the form of a computer system within which a set of instructions, when executed, may cause the machine to perform any one or more of the methodologies discussed herein.

### DETAILED DESCRIPTION

One embodiment of the present disclosure entails a communication device having a transceiver for establishing communications with other communication devices, a User Interface (UI), one or more electromechanical elements, a controller that manages operations of the transceiver, the UI, and the one or more electromechanical elements, and a housing assembly with an ergonomic form-factor having a plurality of subassemblies for carrying in whole or in part the transceiver, the UI, the one or more electromechanical elements, and the controller. The controller can be adapted to detect one of a plurality of communication events, and cause at least one of the one or more electromechanical elements to adjust the ergonomic form-factor so that it is suitable for the detected communication event.

Another embodiment of the present disclosure entails a computing device having a UI, one or more electromechanical elements, a controller that manages operations of the UI, and the one or more electromechanical elements, and a housing assembly with an ergonomic form-factor for carrying in whole or in part the UI, the one or more electromechanical elements, and the controller. The controller can be adapted to detect a triggering event, and cause at least one of the one or more electromechanical elements to adjust the ergonomic form-factor responsive to the detected triggering event.

Yet another embodiment of the present disclosure entails a method involving adjusting an ergonomic form-factor of a housing assembly of a computing device with one or more electromechanical elements responsive to the computing device detecting a triggering event associated with a communication session, a presentation session, a stimulus applied to a UI of the computing device, or combinations thereof.

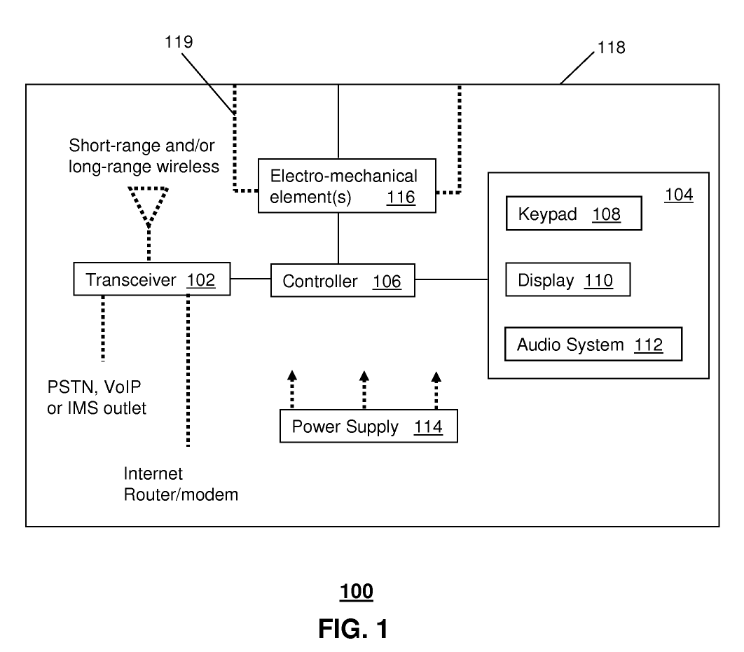

FIG. 1 depicts an exemplary embodiment of a computing device 100. The computing device 100 can comprise a wireline and/or wireless transceiver 102 (herein transceiver 102), a user interface (UI) 104, a power supply 114, and a controller 106 for managing operations thereof. The transceiver 102 can support short-range or long-range wireless access technologies such as a Bluetooth wireless access protocol, a Wireless Fidelity (WiFi) access protocol, a Digital Enhanced Cordless Telecommunications (DECT) wireless access protocol, cellular, software defined radio (SDR) and/or WiMAX technologies, just to mention a few. Cellular technologies can include, for example, CDMA-1X, UMTS/HSDPA, GSM/GPRS, TDMA/EDGE, EV/DO, and next generation technologies as they arise.

The transceiver 102 can also support common wireline access technologies such as circuit-switched wireline access technologies, packet-switched wireline access technologies, or combinations thereof. PSTN can represent one of the common circuit-switched wireline access technologies. Voice over Internet Protocol (VoIP), and IP data communications can represent some of the commonly available packet-switched wireline access technologies. The transceiver 102 can also be adapted to support IP Multimedia Subsystem (IMS) protocol for interfacing to an IMS network that can combine PSTN and VoIP communication technologies.

The UI 104 can include a depressible or touch-sensitive keypad 108 and a navigation mechanism such as a roller ball, joystick, and/or navigation disk for manipulating operations of the computing device 100. The UI 104 can further include a display 110 such as monochrome or color LCD (Liquid Crystal Display), OLED (Organic Light Emitting Diode) or other suitable display technology for conveying images to the end user of the computing device 100. In an embodiment where the display 110 is touch-sensitive, a portion or all of the keypad 108 can be presented by way of the display. The UI 104 can also include an audio system 112 that utilizes common audio technology for conveying low volume audio (e.g., audio heard only in the proximity of a human ear) and high volume audio (e.g., speakerphone for hands free operation). The audio system 112 can further include a microphone for receiving audible signals of an end user.

The power supply 114 can utilize common power management technologies such as replaceable and rechargeable batteries, supply regulation technologies, and charging system technologies for supplying energy to the components of the computing device 100 to facilitate long-range or short-range portable applications.

Computing device 100 can also include one or more electromechanical elements (EMEs) 116 for adjusting an ergonomic form-factor of a housing assembly 118 that carries in whole or in the components of the computing device. The EMEs 116 can comprise one or more common micro-linear motors and/or electro-active polymers typically referred to as an EAPs. Micro-linear motors can be designed with minimal moving parts by utilizing, for example, piezoelectric actuators that linear displace a shaft. The piezoelectric actuators can be stimulated to vibrate in a known manner thereby causing a controlled movement of the shaft inwards or outwards. Because of its small size, micro-linear motors can be utilized in consumer products of small volume.

EAPs can be electrical or ionic. Electric EAPs can be ferroelectric polymers. Poly (vinylidene fluoride) or PVDF are copolymers commonly exploited as ferroelectric polymers. They can consist of a partially crystalline component in an inactive amorphous phase. Large AC fields (e.g., 200 MV/m) can induce electrostrictive (non-linear) strains. Other forms of electric EAPs include dialectric EAPs, Electrostrictive Graft Elastomers, Electrostrictive Paper, Electro-Viscoelastic Elastomers, and Liquid Crystal Elastomer (LCE) materials. Each of these materials can be stimulated with electric charges to its shape.

Common ionic EAPs can include Ionic Polymer Gels (IPGs), Ionomeric Polymer-Metal Composites (IPMC), Conductive Polymers (CPs), or Carbon Nanotubes (CNTs). One or more of these materials can be used to emulate the force and energy density of biological muscles. For example IPMCs can be stimulated with an electrical charge to bend as a result of the mobility of cations in the polymer network.

EAPs can be placed on one or more outer surfaces of the housing assembly 118 to adjust the ergonomic form-factor of the assembly as will be discussed shortly. Micro-linear motors can be placed within a closed portion of the housing assembly 118 or hidden by other means, and similarly utilized to adjust the ergonomic form-factor of the housing assembly as will be described below. Reference 119 illustrates that some EMEs 116 can be placed outside of the housing assembly 118 while others can be located within an enclosed portion of the housing assembly.

The controller 106 can utilize common computing technologies such as a microprocessor and/or digital signal processor (DSP) with associated storage memory such as Flash, ROM, RAM, SRAM, DRAM or other storage technologies for controlling the components of the computing device 100. The controller 106 can be utilized to control the aforementioned components 102, 104, 116, and 118.

The computing device 100 as described above can represent a cellular phone, a cordless phone, a laptop computer, a personal digital assistant, a media player (e.g., MP3/MP4 player such as an iPod™), a gaming device (e.g., Gameboy™) and variants and/or combinations thereof. It would be apparent to an artisan of ordinary skill that the computing device 100 can represent any of a number of present or next generation devices utilized by consumers for communications, entertainment or other suitable means.

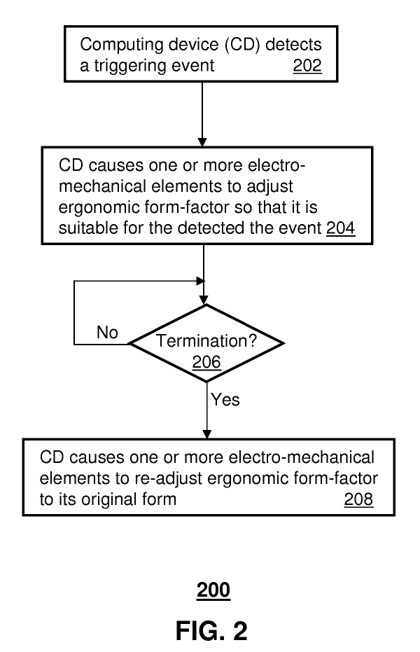

FIG. 2 depicts an illustrative method 200 operating in the computing device 100 of FIG. 1. Method 200 can begin with step 202 where the computing device 100 detects a triggering event. A triggering event can represent a communication activity, a presentation activity, a stimulus applied to the UI 104, an event generated by a software application operating in the computing device 100, or combinations thereof. Software applications can come in many informs including an operating system, a phone book application, a communication log application, a web browser application, an email application, a still image and/or video camera application, a calendar application for scheduling events, a GPS navigation application, and so on. It would be apparent to an artisan with ordinary skill in the art that a triggering event can result from an external stimulus or stimuli applied to the computing device 100, and/or operational aspects of the computing device that are capable of generating events that can be acted on.

A communication activity can represent an incoming voice communication event, an outgoing voice communication event, an outgoing data communication event, an incoming data communication event, or combinations thereof. Upon detecting the triggering event, the computing device 100 can cause in step 204 the one or more EMEs 116 to adjust the ergonomic form-factor of the housing assembly 118 so that it is suitable for the detected event. When the computing device 100 detects a termination of the event in step 206, it can cause the EMEs 116 to re-adjust the ergonomic form-factor in step 208 to its original form.

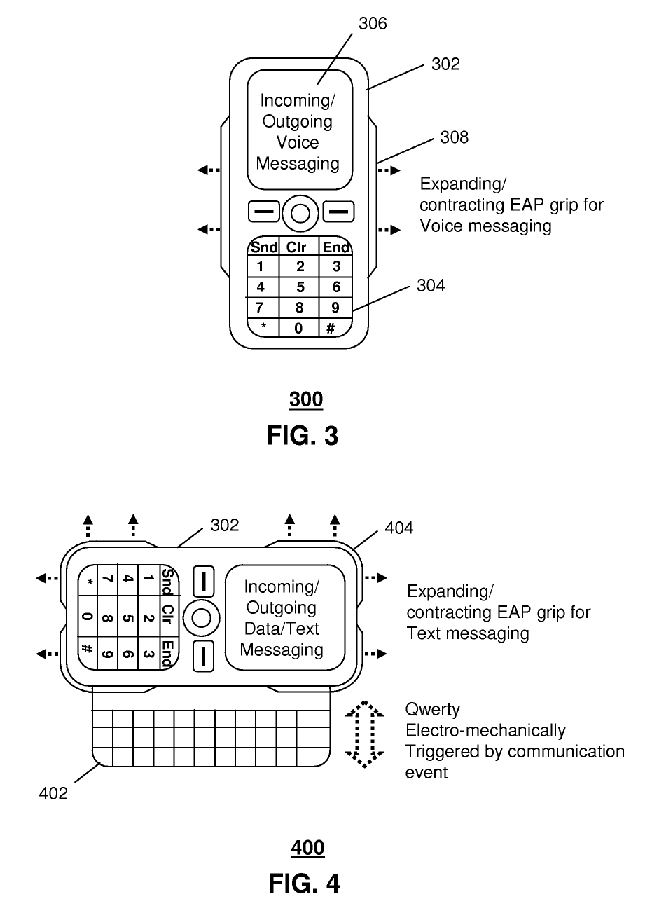

FIGS. 3-8 depict illustrative embodiments of form-factors of the computing device 100 and the application of method 200 thereon. FIG. 3 depicts an illustrative embodiment of a computing device 100 having a housing assembly 118 with an ergonomic form-factor 302 commonly referred to as a “candy bar” form-factor because of its rectangular shape. In this illustration, the computing device 100 is engaged in a voice messaging activity which serves as the triggering event in step 202 of method 200. The voice messaging activity can represent receiving an incoming call, or initiating an outgoing call by a user of the computing device 100 entering a telephone number through a keypad 304 and selecting a send button of said keypad with the results presented by the display 306.

In this illustration, outer surfaces of the housing assembly 118 can include portions of the EMEs 116 in the form of electric and/or ionic EAPs 308 which can be actuated by the controller 106 with controlled electrical charges derived from the power supply 114. When the computing device 100 is utilized for voice messaging, the controller 106 can be programmed to cause the EAPs 308 to expand and reshape the ergonomic form-factor of the housing assembly 118 so that it provides the user of the computing device a better hand grip when holding the device in a vertical “candy bar” position, which is typically the case when a user holds the computing device up to an ear to engage in conversation, listen to voicemail messages or other similar activity.

When the triggering event involves data or text messaging (e.g., SMS, MMS, or email) the user can benefit from holding the “candy bar” form-factor in a horizontal position as shown in FIG. 4 to view text or images in a landscape mode. In this illustrative embodiment, the controller 106 can be programmed to perform three ergonomic adjustments in step 204. First, EAPs 404 can be positioned at the outer corners of the ergonomic form-factor 302. The controller 106 can be programmed to contract the EAPs 308 of FIG. 3, while expand the EAPs 404 of FIG. 4 to provide a better grip while holding the computing device 100 in a landscape position.

The controller 106 can be further programmed to automatically expose a Qwerty keyboard 402 by causing an EME 116 in the form of, for example, a micro-linear motor that forcibly slides the keyboard out of a concealed position of the housing assembly 118. The Qwerty keyboard 402 can be a slideable sub-assembly of the housing assembly 118 having one or two sliders to guide the exposure or concealment of the keyboard. The Qwerty keyboard 402 can reside on the backside of the computing device 100 in a concealed position until the controller 106 engages the EME 116 associated therewith to force its exposure. The micro-linear motor can be designed to control how far the Qwerty keyboard 402 is exposed, or it can be used to trigger a spring-loaded mechanism that causes the keyboard to be exposed. When the controller 106 detects in step 206 that data/text messaging has been terminated, the controller can cause the EMEs 116 associated with the EAP 404 to contract, and the micro-linear motor to retract and thereby conceal the Qwerty keyboard 402 to the backside of the computing device 100.

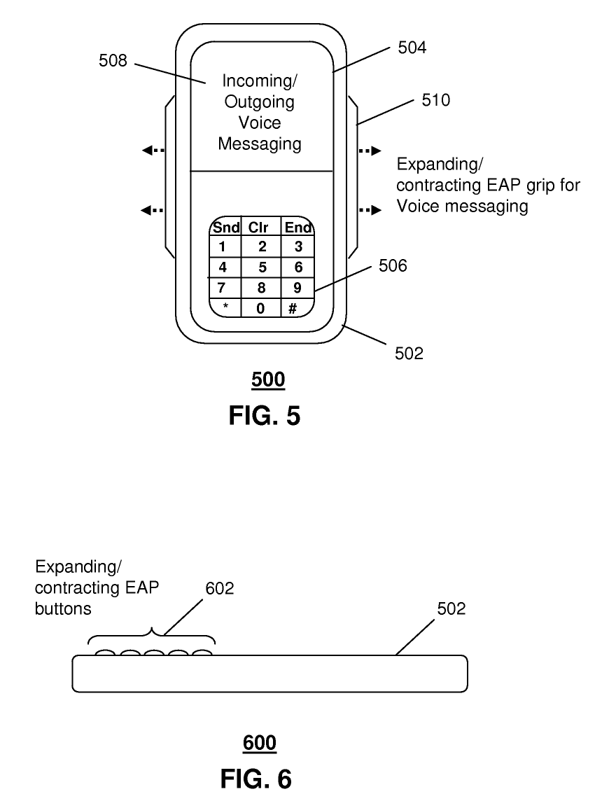

FIG. 5 depicts yet another illustrative embodiment of a computing device 502 with a touch screen display 504 that adapts to applications operating thereon. In a vertical “candy bar” position, the touch-sensitive display 504 can present applications in portrait mode subdivided into a voice messaging section 508 and a input or UI section (e.g., keypad) 506. As in the previous embodiments, an EME 116 such as an EAP can be placed on the sides and adjusted in step 204 by the controller 106 to expand when the controller detects in step 202 incoming or outgoing voice messaging activities. To simulate a tactile keypad, an additional EME 116 in the form of an EAP can be placed on the surface of the touch-sensitive display in the section of the keypad 506. The EAP can be actuated to cause bumps 602 as shown in FIG. 6 that emulate a tactile keypad to provide the user tactile feedback while entering a telephone number. The bumps caused by the EAP 602 can assist the user of the computing device 100 to more precisely utilize the functions of the keypad 506.

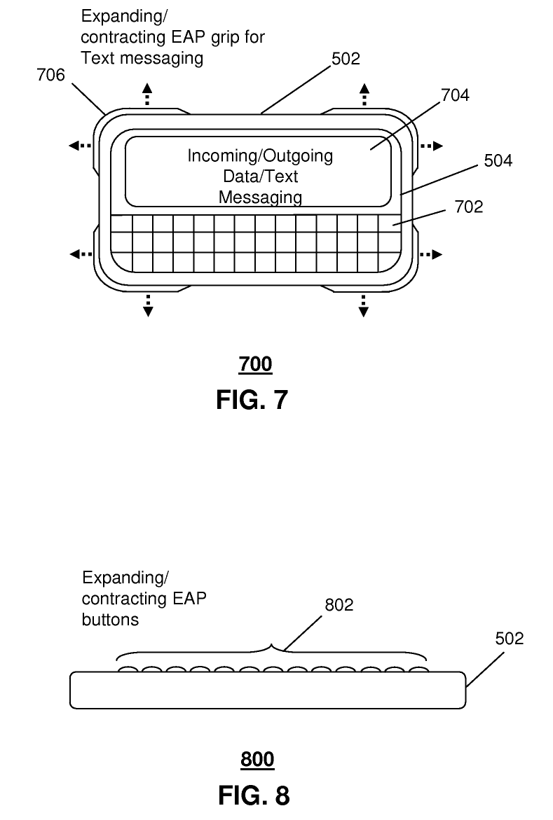

In a horizontal “candy bar” position, the touch-sensitive display 504 can be subdivided into a text/data messaging section 704 and a input section (e.g., Qwerty keyboard) 702 as shown in FIG. 7. The landscape display mode can be actuated by the controller 106 after detecting a horizontal position as shown with a common accelerometer coupled to the controller. EMEs 116 in the form of EAPs can be placed on the outer corner surfaces of the housing assembly 118 and actuated by the controller 106 when data/text messaging activities are detected, or the controller switches to a landscape touch-sensitive display position responsive to detecting a signal from the accelerometer. EMEs 116 in the form of EAPs can also be added to a portion of the display surface encompassing the Qwerty keyboard 702. The controller 106 can cause the EAPs to emulate tactile feedback bumps 802 to provide the user a more precise sense of key entry with the Qwerty keyboard 702.

The embodiments of FIGS. 3-8 are illustrative and are a limited subset of other possible embodiments of the present disclosure. Accordingly, it would be evident to an artisan with ordinary skill in the art that said embodiments can be modified, reduced, or enhanced without departing from the scope and spirit of the claims described below. For example, the present disclosure can be applied to gaming applications which depending on the circumstances of the game may trigger EMEs 116 in the form of micro-linear motors and/or EAPs in ways different from what has been described herein.

Similarly, concealed sub-assemblies of the housing assembly 118 of a computing device 100 can have different orientations than what has been shown. For instance a hidden Qwerty keyboard may be exposed by the controller 106 when actuating one or more EMEs 116 during a vertical “candy bar” position (i.e., extending below an already exposed keypad such as shown in FIG. 3).

In yet another illustrative embodiment, EAPs can be adapted according to a user's preferences. For example, a touch-sensitive display may provide the option to increase or decrease the size of a keypad or Qwerty keyboard. The controller 106 can be programmed to adjust the size of the bumps created by EAPs to the adapted keypad or Qwerty keyboard.

In another embodiment, software applications or clients operating in the computing device 100 can generate triggering events with or without an external stimulus. Internal software triggers can also cause the controller 106 to direct one or more EMEs 116 to change the ergonomic form-factor of the computing device. For example, a calendar application can generate a triggering event such as a calendar appointment which can cause the computing device 100 to automatically initiate a voice communication session according to a communication identifier associated with the appointment, and on or before the communication session, adjust the ergonomic form-factor of the computing device by engaging one or more EMEs 116 in a manner that improves the user's ergonomic experience while engaging in a voice communication session.

It should also be noted that the present disclosure can be applied to other form-factors including, for example, “flip” form-factors used by cellular phones and laptop computers.

Other suitable modifications can be applied to the present disclosure. Accordingly, the reader is directed to the claims section for a fuller understanding of the breadth and scope of the present disclosure.

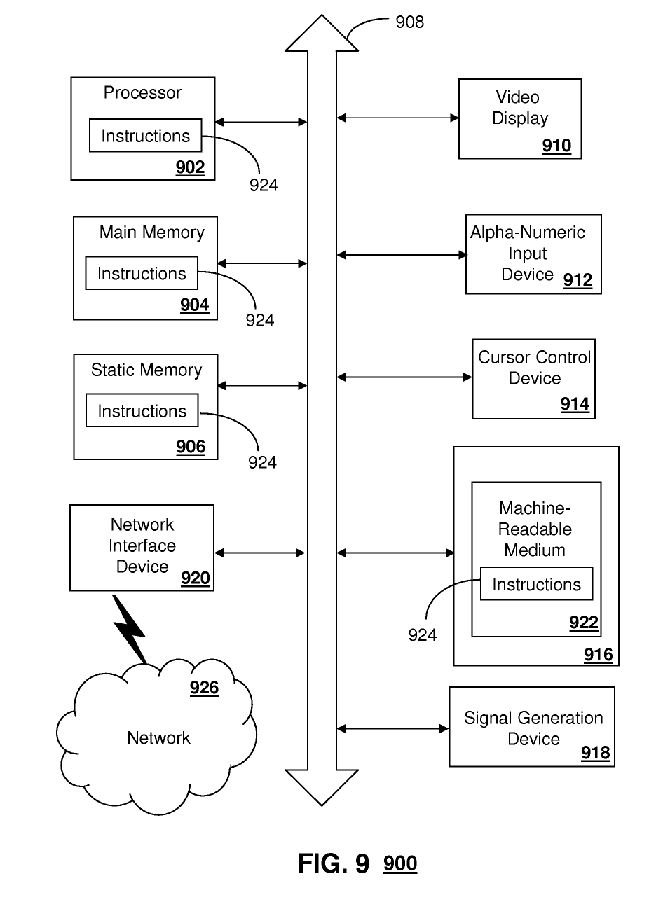

FIG. 9 depicts an exemplary diagrammatic representation of a machine in the form of a computer system 900 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 900 may include a processor 902 (e.g., a central processing unit (CPU), a graphics processing unit (GPU, or both), a main memory 904 and a static memory 906, which communicate with each other via a bus 908. The computer system 900 may further include a video display unit 910 (e.g., a liquid crystal display (LCD), a flat panel, a solid state display, or a cathode ray tube (CRT)). The computer system 900 may include an input device 912 (e.g., a keyboard), a cursor control device 914 (e.g., a mouse), a disk drive unit 916, a signal generation device 918 (e.g., a speaker or remote control) and a network interface device 920.

The disk drive unit 916 may include a machine-readable medium 922 on which is stored one or more sets of instructions (e.g., software 924) embodying any one or more of the methodologies, functions or internal software applications described herein, including those methods illustrated above. The instructions 924 may also reside, completely or at least partially, within the main memory 904, the static memory 906, and/or within the processor 902 during execution thereof by the computer system 900. The main memory 904 and the processor 902 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 924, or that which receives and executes instructions 924 from a propagated signal so that a device connected to a network environment 926 can send or receive voice, video or data, and to communicate over the network 926 using the instructions 924. The instructions 924 may further be transmitted or received over a network 926 via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A communication device, comprising:
a transceiver for establishing communications with other communication devices;
a User Interface (UI);
one or more electromechanical elements;
a controller that manages operations of the transceiver, the UI, and the one or more electromechanical elements; and
a housing assembly with an ergonomic form-factor having a plurality of subassemblies for carrying in whole or in part the transceiver, the UI, the one or more electromechanical elements, and the controller,
wherein the controller is adapted to:
detect one of a plurality of communication events, and
cause at least one of the one or more electromechanical elements to adjust the ergonomic form-factor so that it is suitable for the detected communication event.

2. The communication device of claim 1, wherein the UI comprises at least one of a keyboard, a display, or an audio system.

3. The communication device of claim 2, wherein the keyboard corresponds to at least one of a qwerty keyboard, a numeric keyboard, and combinations thereof.

4. The communication device of claim 1, wherein the plurality of communication events comprise at least two of an outgoing voice communication event, an incoming voice communication event, an outgoing data communication event, an incoming data communication event, one or more triggering events of the UI, and combinations thereof.

5. The communication device of claim 1, wherein the detected communication event comprises an event generated by the UI initiating a communication session, or an incoming message initiating the communication session, wherein the UI comprises a keyboard, and wherein the controller is adapt to:
cause the one or more electromechanical elements to adjust the ergonomic form-factor to expose the keyboard;
detect a termination of the communication session; and
cause the one or more electromechanical elements to adjust the ergonomic form-factor to conceal the keyboard.

6. The communication device of claim 5, wherein the keyboard corresponds to one of a numeric keyboard or a qwerty keyboard, wherein the one or more electromechanical elements adjust the ergonomic form-factor to expose the keyboard with a linear mechanism of at least one of the subassemblies, by triggering a spring-loaded portion of at least one of the subassemblies, or combinations thereof, and wherein the one or more electromechanical elements adjust the ergonomic form-factor to conceal the keyboard with the linear mechanism of the at least one subassembly, by triggering a reversal of the spring-loaded portion of the at least one subassembly, or combinations thereof

7. The communication device of claim 1, wherein the UI comprises a keyboard, and wherein the controller is adapt to cause the one or more electromechanical elements to adjust the ergonomic form-factor to create or augment a tactile feel of one or more keys of the keyboard.

8. The communication device of claim 1, wherein the UI comprises a touch-sensitive display, and wherein the controller is adapt to cause the one or more electromechanical elements to adjust the ergonomic form-factor to create a tactile feel of at least a portion of the touch-sensitive display.

9. The communication device of claim 8, wherein the portion of the touch-sensitive display corresponds to a touch-sensitive keypad, and wherein the controller is adapted to cause the one or more electromechanical elements to adjust the ergonomic form-factor to create a tactile feel of one or more keys of the touch-sensitive keypad.

10. The communication device of claim 1, wherein the controller is adapt to cause the one or more electromechanical elements to adjust the ergonomic form-factor to create a change in a tactile feel of at least a portion of one or more surfaces of the housing assembly.

11. The communication device of claim 1, wherein each of the one or more electromechanical elements comprises at least one of a linear motor and an electro-active polymer (EAP).

12. The communication device of claim 11, wherein the linear motor comprises one or more electro-active ceramic actuators.

13. The communication device of claim 11, wherein the EAP comprises one of an electric EAP, an ionic EAP, or combinations thereof, and wherein a portion or all of the EAP is placed on one or more outer surfaces of the housing assembly or is an integral part thereof.

14. The communication device of claim 1, wherein the ergonomic form-factor of the housing assembly, and adjustments thereof by the controller by way of an activation or deactivation of the one or more electromechanical elements influences an ease of use of the communication device.

15. A computing device, comprising:
a User Interface (UI);
one or more electromechanical elements;
a controller that manages operations of the UI, and the one or more electromechanical elements; and
a housing assembly with an ergonomic form-factor for carrying in whole or in part the UI, the one or more electromechanical elements, and the controller,
wherein the controller is adapted to:
detect a triggering event; and
cause at least one of the one or more electromechanical elements to adjust the ergonomic form-factor responsive to the detected triggering event.

16. The computing device of claim 15, wherein the computing device corresponds to a communication device with a transceiver, and wherein the triggering event is associated with a communication session, a presentation session, the UI, a software application managed by the controller, or combinations thereof.

17. The computing device of claim 15, wherein each of the one or more electromechanical elements comprises at least one of a linear motor and an electro-active polymer.

18. The computing device of claim 15, wherein the adjustment of the ergonomic form-factor corresponds to an ergonomic adjustment of the UI.

19. The computing device of claim 18, wherein the UI comprises at least one of a keyboard, a display, and an audio system.

20. The computing device of claim 19, wherein the ergonomic adjustment to the UI comprises a tactile adjustment of one or more keys of the keypad, or one or more keys of a touch-sensitive keypad of the display.

21. The computing device of claim 15, wherein the adjustment of the ergonomic form-factor creates a change in a tactile feel of at least a portion of one or more surfaces of the housing assembly.

22. A method, comprising adjusting an ergonomic form-factor of a housing assembly of a computing device with one or more electromechanical elements responsive to the computing device detecting a triggering event associated with a communication session, a presentation session, a stimulus applied to a User Interface (UI) of the computing device, or combinations thereof.

23. The method of claim 22, wherein each of the one or more electromechanical elements comprises at least one of a linear motor and an electro-active polymer (EAP).

24. The method of claim 22, wherein the adjustment of the ergonomic form-factor corresponds to an ergonomic adjustment of the UI, one or more surfaces of the housing assembly, or combinations thereof.

25. The method of claim 22, wherein the UI comprises at least one of a keyboard, a display, and an audio system.
